(19) United States
(12) Patent Application Publication
(10) Pub. No.: US 2012/0209436 A1
(43) Pub. Date: Aug. 16, 2012

(54) FLUID CONTROL DEVICE AND PRESSURE CONTROL DEVICE

(75) Inventors: Koutarou Takijiri, Kyoto-shi (JP); Yutaka Yoneda, Kyoto-shi (JP)

(73) Assignee: HORIBA STEC, CO., LTD., Kyoto-shi (JP)

(21) Appl. No.: 13/397,528

(22) Filed: Feb. 15, 2012

(30) Foreign Application Priority Data
Feb. 15, 2011 (JP) 2011-030302
Feb. 15, 2011 (JP) 2011-030304
Feb. 15, 2011 (JP) 2011-030305

(51) Int. Cl. G05D 7/00

(52) U.S. Cl. 700/282

(57) ABSTRACT

A fluid control device that can, with a digitally controlled valve controller, achieve responsiveness close to conventional analog control is provided with: a fluid control valve in a flow path through which fluid flows; fluid measurement parts that measure a physical quantity related to the fluid; and a valve controller configured to control, on the basis of a deviation between a physical quantity value measured in the fluid measurement part and a preliminarily set setting value, a fluid control valve's opening level by digital control. The valve controller 4 is provided with: an operation amount calculation part configured to perform calculation on an inputted value to output a value related to an operation amount for the opening level of the fluid control valve; and a phase compensation part configured to output a value obtained by compensating an inputted value for a phase shift by velocity type digital calculation.

### TECHNICAL FIELD

The present invention relates to a fluid control device and a pressure control device for controlling pressure, flow rate, and the like of fluid flowing through a flow path.

### BACKGROUND ART

In the case of supplying various types of gases and the like used for semiconductor manufacturing to a semiconductor manufacturing apparatus, a fluid control device such as a mass flow controller and a pressure control device that is a sort of a fluid control device are provided in each of the supply flow paths so as to control pressure and a flow rate of a corresponding gas.

Taking the case of performing flow rate control as an example, the mass flow controller is provided with: a flow rate control valve that is provided in a flow path; a flow rate sensor configured to measure a flow rate of fluid; and a valve controller configured to control, on the basis of a deviation between a setting flow rate and the measured flow rate, an opening level of the flow rate control valve.

Further, taking the case of performing pressure control as an example, the pressure control device is provided with: a fluid control valve that is provided in a flow path; a pressure sensor configured to measure pressure of fluid; and a valve controller configured to control, on the basis of a deviation between the measured pressure value and a pressure setting value, an opening level of the fluid control valve.

For example, as disclosed in Patent literature 1, the valve controller is configured to mainly have an electronic circuit, and is provided with an operation amount calculation part configured to perform a PID calculation or the like on an inputted value, such as a deviation to calculate a feedback value to be inputted to the fluid control valve. That is, the fluid control device is configured to control the flow rate control valve by analog control (continuous time control).

Meanwhile, in recent years, the flow rate control device such as a mass flow controller is required to reduce manufacturing costs and also further decrease variation in control accuracy among devices. For this reason, the present inventors have attempted to apply a computer program-based digital control (discrete time control) that facilitates accuracy control and easily reduces manufacturing costs, in place of analog control that is likely to give rise to a variation in control performance among the fluid control devices because the accuracy control of an electronic circuit for control or the like is difficult, and also causes the manufacturing costs to be relatively high due to a longer assembly time or the like.

However, a simple change of control method, in which a control method of the valve controller is simply switched from the conventional analog control to digital control, does not enable responsiveness attainable by analog control to be attained by digital control.

Also, from another perspective, a valve control mechanism disclosed in Patent literature 1 is configured to mainly have the electronic circuit, and therefore can also be said to be configured to control the flow rate control valve by analog control (continuous time control). As disclosed in Patent literature 1, the valve control mechanism is one that is provided with: the operation amount calculation part configured to perform the PID calculation on the deviation to calculate a valve operation amount; and a phase compensation part configured to compensate for a phase delay. As described, by making the phase compensation, control is prevented from becoming unstable in the case of high speed response or in other cases, and flow rate control or the like is performed with responsiveness having the required accuracy.

As described above, in recent years, it has been necessary to reduce manufacturing costs of the mass flow controller, and in order to respond to this requirement, a control method of the valve control mechanism has been switched to computer program-based digital control (discrete time control), which easily reduces manufacturing costs, from analog control, which is likely to cause manufacturing costs to be relatively high due to the need to control the precision of the electronic circuits and other components, and the longer assembling time, etc..

However, if the control method of the valve control mechanism is switched from analog control to digital control, the responsiveness achievable by analog control cannot sometimes be achieved in the digital control case because of a quantization error at the time of taking sensor output, the presence of a sampling period, or the like. More specifically, even if in the case where between a signal for controlling the fluid control valve and a signal from the flow rate sensor or the like, a phase delay occurs, the phase compensation is made in a software manner, performance may be deteriorated as compared with the analog control case. In order to solve such a problem to achieve the same responsiveness as in the analog control case, it is considered that, for example, a sampling period is decreased to increase the number of sampling attempts, or in order to keep control stability, noise filtering processing is performed; however, high load calculation processing is required to require a high performance and expensive CPU or the like, and consequently an effect of reducing manufacturing costs is produced less than expected. That is, in the case of switching analog control to digital control in the fluid control device, it is very difficult to achieve a balance between manufacturing costs and responsiveness.

### CITATION LIST

### Patent Literature

Patent literature 1; JPA Showa-64-54518

### SUMMARY OF INVENTION

### Technical Problem

The present invention is made in consideration of the above problem, and has an object of providing a fluid control device that can, even with use of a valve controller employing digital control, achieve responsiveness close to that in the case of using conventional analog control.

Also, the present invention is made in consideration of the above problem, and has an object to provide a fluid control device that can, even with use of a valve control mechanism employing digital control, achieve responsiveness close to that for the case of using conventional analog control while enjoying a cost reduction effect due to digital control.

### Solution to Problem

That is, a fluid control device of the present invention is provided with: a fluid control valve that is provided in a flow path through which fluid flows; a fluid measurement part configured to measure a physical quantity related to the fluid; and a valve controller configured to control, on the basis of a deviation between a physical quantity measured value that is measured in the fluid measurement part and a setting value that is preliminarily set, an opening level of the fluid control valve, wherein the valve controller is provided with: an operation amount calculation part configured to perform a predetermined calculation on an inputted value to output a value related to an operation amount for the opening level of the fluid control valve; and a phase compensation part configured to output a value obtained by compensating an inputted value for a phase shift by velocity type digital calculation.

More specifically, in the case of switching from analog control to digital control, calculation expressions and the calculation method used in analog control should be converted to those for digital control. The present inventors have first found as a result of repeating intensive examination that even if position type digital calculation, which is typically often used at the time of switching from analog control to digital control, is used to compensate for a phase shift, it is difficult to achieve the same responsiveness as that at the time of analog control, whereas regarding fluid control using the fluid control valve, by further adding the phase compensation part using velocity type digital calculation to the operation amount calculation part, the same responsiveness as in the conventional case can be achieved.

That is, by configuring the phase compensation part to make the phase compensation by velocity type digital calculation, as compared with the case of using analog control, manufacturing costs are reduced, and at the same time, regarding responsiveness, the same performance as in the conventional case can also be kept.

Specific embodiments of the operation amount calculation part include one in which the predetermined calculation used in the operation amount calculation part is a PID calculation.

In order to further improve the responsiveness in digital control, the predetermined calculation used in the operation amount calculation part is only required to be a velocity type digital calculation.

Further, a pressure control device of the present invention is provided with: a fluid control valve that is provided in a flow path through which fluid flows; a pressure sensor configured to measure pressure of the fluid; and a valve controller configured to control an opening level of the fluid control valve such that a measured pressure value measured in the pressure sensor becomes equal to a setting value that is preliminarily set, wherein the valve controller is provided with: an operation amount calculation part configured to perform a predetermined calculation on an inputted value to calculate a value related to an operation amount for the opening level of the fluid control valve; and a phase compensation part configured to output a value obtained by compensating an inputted value for a phase shift by digital calculation.

The present inventors have found as a result of intensive examination that as described, by adding the phase compensation part based on digital control together with the operation amount calculation part, even in the case of using digital control, the same responsiveness as in the analog control case can be achieved.

Specific configurations of the phase compensation part includes one in which the phase compensation part is configured to compensate for the phase shift by velocity type digital calculation. More specifically, in the case of switching from analog control to digital control, calculation expressions and calculation method used in analog control should be converted to those for digital control. The present inventors have also found as a result of repeating intensive examination that even if the position type digital calculation, which is typically used at the time of switching from analog control to digital control, is used to compensate for a phase shift, it is difficult to achieve the same responsiveness as that at the time of analog control, whereas regarding the fluid control using the fluid control valve, by using the phase compensation part configured to perform velocity type digital calculation, the same responsiveness as in the conventional case can be achieved.

That is, by configuring the phase compensation part to make the phase compensation by velocity type digital calculation, as compared with the case of using analog control, manufacturing costs are reduced, and at the same time, regarding the responsiveness, the same performance as in the conventional case can also be kept.

Specific embodiments of the operation amount calculation part include one in which the operation amount calculation part calculates the value related to the operation amount by PID calculation.

In order to further improve the responsiveness in digital control, the operation amount calculation part is only required to calculate the value related to the operation amount by velocity type digital calculation.

Further, a fluid control device of the present invention is provided with: a fluid measurement part that is provided in a flow path through which fluid flows, and measures a physical quantity related to the fluid; a fluid control valve that is provided in the flow path; and a valve control mechanism configured to control, on the basis of a deviation between a physical quantity measured value that is measured in the fluid measurement part and a setting value that is preliminarily set, an opening level of the fluid control valve, wherein the valve control mechanism is provided with: an operation amount calculation part configured to perform a predetermined calculation on an inputted value to output a value related to an operation amount for the opening level of the fluid control valve; and a phase compensation part that is an analog controller and configured to compensate an inputted value for a phase shift to provide an output.

More specifically, the present inventors have found as a result of repeating intensive examination that, by not using digital control in the whole of the valve control mechanism, but by using digital control for the operation amount calculation part and analog control for the phase compensation part, deterioration in control performance, which occurs at the time of switching to digital control, can be compensated for, and the same responsiveness as in the conventional case can be achieved.

That is, by configuring the operation amount calculation part to use digital control, and the phase compensation part to make the phase compensation by analog control, as compared with the case of using analog control for the whole of the valve control mechanism, manufacturing costs are reduced, and at the same time, regarding responsiveness, the same performance as in the conventional case can also be kept.

Specific embodiments of the operation amount calculation part include one in which the operation amount calculation part calculates the value related to the operation amount by PID calculation.

In order to further improve the responsiveness in digital control, the operation amount calculation part is only required to calculate the value related to the operation amount by velocity type digital calculation.

### Advantageous Effects of Invention

As described, the present invention can achieve the same responsiveness as in the conventional analog control case and also reduce manufacturing costs by using digital control for the operation amount calculation part and analog control for the phase compensation part.

Also, even in the case of controlling the fluid control valve by digital control, the phase compensation part makes the phase compensation by velocity type digital calculation, and thereby the present invention can achieve the same responsiveness as in the conventional analog control case and also reduce manufacturing costs.

Further, the present invention can achieve the same responsiveness as in the conventional analog control case and also reduce manufacturing costs by using digital control for the operation amount calculation part and analog control for the phase compensation part.

### BRIEF DESCRIPTION OF THE DRAWINGS

FIG. 1 is a schematic diagram illustrating a mass flow controller according to a first embodiment of the present invention;

FIG. 2 is a block diagram illustrating a configuration of a control system in the first embodiment;

FIG. 3 illustrates graphs for comparing step response characteristics among respective control methods;

FIG. 4 is a schematic diagram illustrating a pressure control device according to a second embodiment of the present invention;

FIG. 5 is a block diagram illustrating a configuration of a control system in the second embodiment;

FIG. 6 is a schematic diagram illustrating a mass flow controller according to another embodiment;

FIG. 7 is a block diagram illustrating a configuration of a control system in another embodiment;

FIG. 8 is a schematic diagram illustrating a mass flow controller according to a third embodiment of the present invention;

FIG. 9 is a block diagram illustrating a configuration of a control system in the third embodiment;

FIG. 10 illustrates graphs for comparing step response characteristics among respective control methods;

FIG. 11 is a schematic diagram illustrating a pressure control device according to another embodiment of the present invention;

FIG. 12 is block diagram illustrating a configuration of a control system in another embodiment;

FIG. 13 is a schematic diagram illustrating a mass flow controller according to a fourth embodiment of the present invention;

FIG. 14 is block diagram illustrating a configuration of a control system in the fourth embodiment;

FIG. 15 is a schematic diagram illustrating an analog circuit that constitutes a phase compensation part in the fourth embodiment;

FIG. 16 illustrates graphs for comparing step response characteristics among respective control methods;

FIG. 17 is a schematic diagram illustrating a pressure control device according to a fifth embodiment of the present invention;

FIG. 18 is a block diagram illustrating a configuration of a control system in the fifth embodiment;

FIG. 19 is a schematic diagram illustrating a mass flow controller according to another embodiment; and

FIG. 20 is a block diagram illustrating a configuration of a control system in another embodiment.

### DETAILED DESCRIPTION OF THE EMBODIMENTS

In the following, a first embodiment of the present invention is described with reference to the drawings.

A fluid control device 100 of the first embodiment is one that is, in a semiconductor manufacturing apparatus, used to introduce any of various types of gases at a desired flow rate or pressure into a chamber where deposition or etching is performed. More specifically, the fluid control device 100 is one that is connected to each of the pipes connected to the chamber, and controls the corresponding gas flowing through the pipe as a flow path 5.

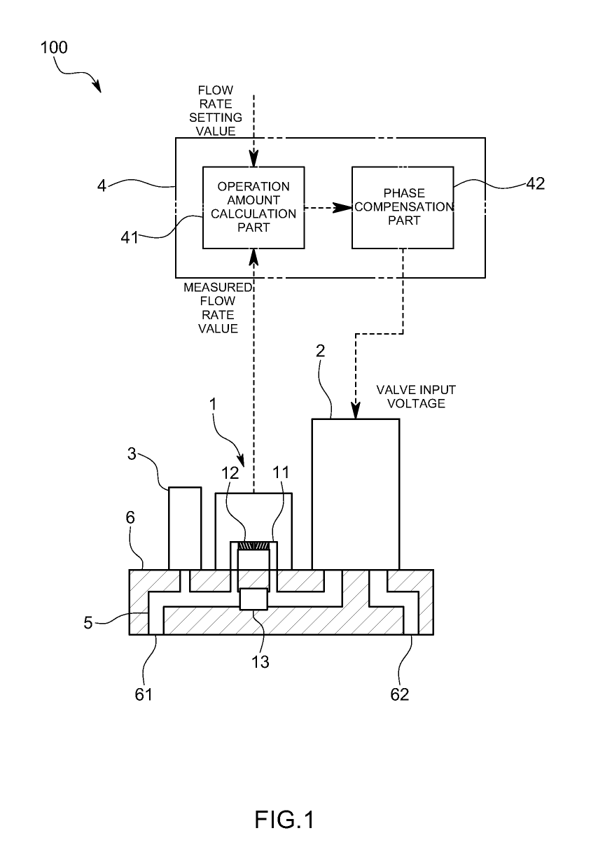

The fluid control device 100 is a so-called mass flow controller, and as illustrated in FIG. 1, is provided with: a body 6 inside which the flow path 5 is formed; a pressure sensor 3, a flow rate sensor 1, and a fluid control valve 2 that are sequentially provided from an upstream side of the flow path 5; and a valve controller 4 configured to control, on the basis of output of the flow rate sensor 1, an opening level of the fluid control valve 2, in which the respective parts are packaged as one casing. In addition, in the present embodiment, fluid serving as a control target is gas such as helium; however, the present invention can also be applied to other gas used for semiconductor manufacturing.

Each of these parts is described below.

The body 6 is a block body having a substantially rectangular parallelepiped shape, inside which a penetration path is formed to thereby form the flow path 5 through which the fluid flows. On a bottom surface of the body 6, an introduction port 61 that is a start point of the flow path 5, and a lead-out port 62 that is an end point are provided. An introduction port 61 and a lead-out port 62 are used with being connected to connection ports of a gas panel (not illustrated) that is used in a semiconductor manufacturing process or the like in place of pipes or the like and has flow paths inside. Also, an upper surface of the body 6 is attached with the flow rate sensor 1, the fluid control valve 2, and the pressure sensor 3 to thereby provide the respective sensors and valve on the flow path 5.

The pressure sensor 3 is one that is intended to measure primary side pressure, that is, pressure on an upstream side of the fluid control valve 2. A pressure value detected by the pressure sensor 3 is used for an operation check of various types of devices, or the like.

The flow rate sensor 1 is one configured to measure a flow rate that is a physical quantity of the fluid flowing through the flow path 5, and a so-called thermal flow rate sensor. The flow rate sensor 1 is one that is provided with: a sensor flow path 11 that is formed by a narrow tube so as to branch from the flow path 5 and join the flow path 5 again; a pair of coils 12 that is provided on an outer circumference of the narrow tube; and a laminar flow element 13 that is provided in the internal flow path 5 between a branch point and a junction point of the sensor flow path 11. Also, the flow rate sensor is configured such that voltages are applied to the two coils 12; control is performed such that the respective coils keep a constant temperature, at the same temperature; and on the basis of the respective voltages applied at the time, an unillustrated flow rate calculation part calculates a mass flow rate of the fluid flowing through the flow path 5. Note that, in the present embodiment, the thermal flow rate sensor 1 is one configured to measure a mass flow rate, but may be configured to output a volume flow rate. Also, in the present embodiment, the flow rate sensor 1 corresponds to a fluid measurement part in the claims. Further, the flow rate sensor 1 is not limited to the thermal flow rate sensor, but may be, for example, a differential pressure flow rate sensor. In the case of using the differential pressure flow rate sensor as described, response speed of sensor output with respect to a flow rate change can be improved to further improve responsiveness of fluid control. In addition, the laminar flow element 13 may be a flow path resistor such as an orifice.

The fluid control valve 2 is a solenoid valve, and is adapted to be able to adjust the opening level thereof by moving an unillustrated valve element with an electromagnetic force. In the case of the solenoid valve, initial response speed is high, and therefore the responsiveness of fluid control can be improved. The fluid control valve 2 is not limited to the solenoid valve as well, but may be any other valve having a low response speed as compared with the solenoid valve, such as a piezo valve if the responsiveness of fluid control is allowed to be slightly degraded.

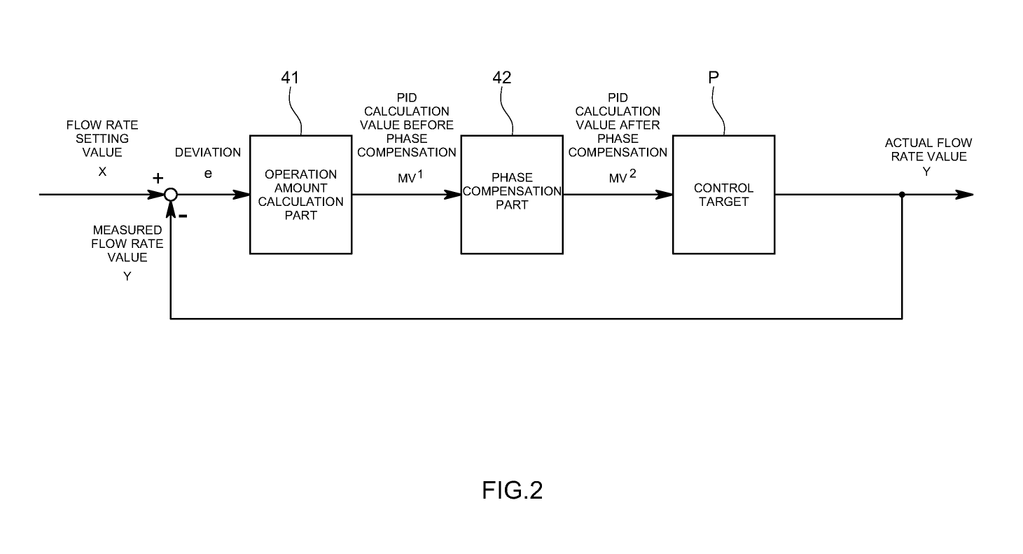

The valve controller 4 is one configured to control the opening level of the fluid control valve 2 by digital control such that a measured flow rate value that is measured by the flow rate sensor 1 becomes equal to a setting value that is preliminarily set. In other words, the valve controller 4 is, on the basis of a deviation between the measured value and the setting value, output a feedback value calculated by digital control to the fluid control valve 2. More specifically, the valve controller 4 is one that uses a so-called computer having a CPU, a memory, an AC/DC converter, and the like to execute various types of programs stored in the memory by the CPU, and thereby realizes the aforementioned function. Also, the valve controller 4 is configured to fulfill functions as at least an operation amount calculation part 41 and a phase compensation part 42. In other words, the valve controller 4 is configured not to be a controller by an analog circuit such as an operational amplifier, but to be a digital controller that realizes the control function by the programs, and configured to return the feedback value to the fluid control valve 2 every control period. In addition, the valve controller 4 is configured such that, under the condition that input is the flow rate setting value and output is the flow rate measured value, a block diagram representing a transfer function from the setting value to the measured value is one as illustrated in FIG. 2. Note that a block in which “Control target” is described in the block diagram represents a transfer function that is described on the basis of characteristics of the fluid control valve 2, characteristics of the fluid, sensor characteristics, and the like of the mass flow controller.

The operation amount calculation part 41 is one configured to perform a predetermined calculation on an inputted value to output a value related to an operation amount for the opening level of the fluid control valve. Here, the inputted value refers to a concept including a value indicated by an inputted electric signal or numerical data itself. In the present embodiment, the value to be inputted to the operation amount calculation part 41 is the deviation between the measured flow rate value that is measured by the flow rate sensor 1 and the setting value that is preliminarily set. That is, the operation amount calculation part 41 is configured to be inputted with the deviation between the measured value and the setting value to calculate the operation amount for the opening level of the fluid control valve 2 on the deviation by PID calculation, and output the resultant output value to the phase compensation part 42. More specifically, the operation amount calculation part 41 has control characteristics corresponding to a calculation expression represented by Expression 1 in a time domain representation in analog control.

$${MV}^{1} = {K}_{p} ( e + \frac{1}{{T}_{I}} \int e d t + {T}_{D} \frac{d e}{d t} ) \qquad [ Expression 1 ]$$

where e is the deviation between the measured value and the setting value; MV¹ is a PID calculation value; Kp is a proportional gain; T_{I} is an integration time; and T_{D} is a derivative time.

In the present embodiment, digital control is used, and therefore the operation amount calculation part 41 performs the calculation on the basis of Expressions 2 and 3, which are converted from Expression 1, so as to calculate the PID calculation value MV₁ by velocity type digital calculation.

MVₙ¹=MVₙ₋₁¹+ΔMVₙ¹ [Expression 2]

$$Δ {MV}_{n}^{1} = {K}_{p} \{ ( {e}_{n} - {e}_{n - 1} ) + \frac{Δ t}{{T}_{I}} {e}_{n} + \frac{{T}_{D}}{Δ t} ( {e}_{n} - 2 {e}_{n - 1} + {e}_{n - 1} ) \} \qquad [ Expression 3 ]$$

where Δt is a control interval; MV¹ₙ is a Manuplated Variable by a PID calculation value in an n-th control period; and ΔMV¹ₙ is a difference between the PID calculation value in the n-th control period and a PID calculation value in an (n−1)-th control period.

That is, as can be seen from Expressions 2 and 3, the operation amount calculation part 41 does not calculate an output value every time, but is configured to calculate only a variation from a previous output value and add the variation to the previous output value to calculate a present output value.

The phase compensation part 42 is one configured to output a value obtained by compensating an inputted value for a phase shift by velocity type digital calculation, and in the present embodiment, configured to compensate for a phase delay. In the present embodiment, the inputted value is the PID calculation value outputted from the operation amount calculation part 41; however, the present invention may be configured to input another value as will be described later. The present embodiment is configured to compensate the PID calculation value inputted from the operation amount calculation part 41 for the phase delay by velocity type digital calculation, and input the resultant value to the fluid control valve 2 as the feedback value. Corresponding control characteristics correspond to a calculation expression represented by Expression 4 in the time domain representation in analog control.

$${MV}^{2} = {MV}^{1} + C \frac{d {MV}^{1}}{d t} \qquad [ Expression 4 ]$$

where MV² is a PID calculation value after the phase compensation; and C is a phase compensation factor.

In the present embodiment, digital control is used, and therefore on the basis of Expressions 5 and 6 that are converted from Expression 4, the phase compensation part 42 performs the calculation so as to output a value after the phase compensation by velocity type digital calculation.

MVₙ²=MVₙ₋₁²+ΔMVₙ² [Expression 5]

$$Δ {MV}_{n}^{2} = {MV}_{n}^{1} - {MV}_{n - 1}^{1} + \frac{C}{Δ t} ( {MV}_{n}^{1} - 2 {MV}_{n - 1}^{1} + {MV}_{n - 2}^{1} ) \qquad [ Expression 6 ]$$

where Δt is the length of the control period; MV¹ₙ is the PID calculation value before the phase compensation in the n-th control period; MV²ₙ is a PID calculation value after the phase compensation in the n-th control period; and ΔMV²ₙ is a difference between the PID calculation value after the phase compensation in the n-th control period and a PID calculation value after the phase compensation in an (n−1)-th control period.

Note that, for ease of comprehension, the operation amount calculation part 41 and the phase compensation part 42 are described as ones performing the calculations based on exact differentials; however, in order to further improve the responsiveness, in the flowing description, for example, by replacing Expression 3 with Expression 7, and Expression 6 with Expression 8, the operation amount calculation part 41 and the phase compensation part 42 perform calculations with the use of inexact differentials, as described below. In addition, they may perform the calculations with the use of exact differentials depending on the intended purpose such as control, or allowable error.

$$\begin{matrix}Δ {MV}_{n}^{1} = {K}_{p} \{ ( {e}_{n} - {e}_{n - 1} ) + \frac{Δ t}{{T}_{I}} {e}_{n} + \frac{{T}_{D}}{Δ t} ( {e}_{n} - 2 {e}_{n - 1} + {e}_{n - 1} ) \} ⇒ Δ {MV}_{n}^{1} = {K}_{p} \{ ( {e}_{n} - {e}_{n - 1} ) + \frac{Δ t}{{T}_{I}} {e}_{n} + Δ {d}_{n}^{1} \} \\ Δ {d}_{n}^{1} = \{ \frac{{η}_{1} {T}_{D}}{Δ t + {η}_{1} {T}_{D}} Δ {d}_{n - 1}^{1} + \frac{{T}_{D}}{Δ t + {η}_{1} {T}_{D}} ( {e}_{n} - 2 {e}_{n - 1} + {e}_{n - 1} ) \} & [ Expression 7 ] \\ Δ {MV}_{n}^{2} = {MV}_{n}^{1} - {MV}_{n - 1}^{1} + \frac{C}{Δ t} ( {MV}_{n}^{1} - 2 {MV}_{n - 1}^{1} + {MV}_{n - 2}^{1} ) ⇒ Δ {MV}_{n}^{2} = {MV}_{n}^{1} - {MV}_{n - 1}^{1} + Δ {d}_{n}^{2} \\ Δ {d}_{n}^{2} = \{ \frac{{η}_{2} C}{Δ t + {η}_{2} C} Δ {d}_{n - 1}^{2} + \frac{C}{Δ t + {η}_{2} C} ( {MV}_{n}^{1} - 2 {MV}_{n - 1}^{1} + {MV}_{n - 2}^{1} ) \} & [ Expression 8 ]\end{matrix}$$

where η₁ and η₂ are time constants.

Next, the responsiveness of the fluid control device 100 of the present embodiment is described.

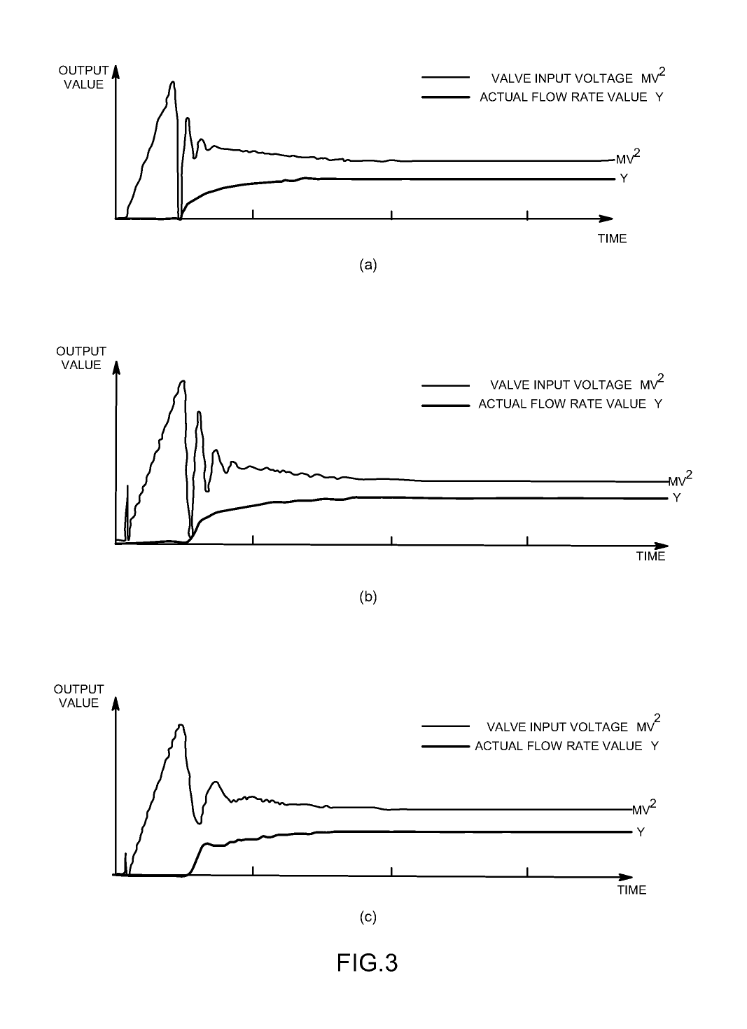

FIGS. 3(a), (b), and (c) respectively illustrate simulation results of a step response of the fluid control device 100 in which the phase compensation part 42 is configured with use of a conventional analog circuit; a step response of the fluid control device 100 of the present embodiment, in which, as described above, the phase compensation part 42 is configured to compensate for the phase delay by velocity type digital calculation; and a step response of the fluid control device 100 in which the phase compensation part 42 is configured to compensate for the phase delay by position type digital calculation. In addition, a thin solid line represents a variation in voltage value corresponding to the feedback value inputted from the phase compensation part 42 to the fluid control valve 2, and a thick solid line represents a measured flow rate value that corresponds to an output value of a corresponding control system and is measured by the flow rate sensor 1.

As is clear from a comparison between FIGS. 3(a) and (b), it turns out that even in digital control, as in the present embodiment, in the case of compensating for the phase delay by velocity type digital calculation, substantially the same responsiveness as in the conventional analog control case can be achieved.

On the other hand, as illustrated in FIG. 3(c), in the case of making the phase compensation by the position type digital calculation expressed by Expression 9, which is different from the present embodiment, a voltage wave form applied to the fluid control valve 2 and a waveform of the measured value are both different from those in the analog control case. In particular, regarding the measured flow rate value, slight overshoot occurs in a rise portion, and the same responsiveness as in the analog control case cannot be achieved.

$${MV}_{n}^{2} = {MV}_{n}^{1} - {MV}_{n - 1}^{1} + \frac{C}{Δ t} ( {MV}_{n}^{1} - {MV}_{n - 1}^{1} ) \qquad [ Expression 9 ]$$

As illustrated in the diagrams, it is expected that the reason why the difference in responsiveness arises between the position type digital control and velocity type digital control is because a control target is gas, and a flow rate nonlinearly varies with respect to a variation in opening level of the fluid control valve 2, or the opening level of the fluid control valve 2 itself also nonlinearly varies with respect to a variation in input voltage, which causes the occurrence of noise influence, so that velocity type digital calculation has a configuration that is more resistant to such noise similarly to the analog control case.

As described, the present inventors have found as a result of trial and error based on the above-described measure experiment and the like that it is only necessary to configure the phase compensation part 42 to compensate for the phase delay by velocity type digital calculation, and thereby the fluid control device 100 of the present embodiment can achieve the same responsiveness as in the conventional analog control case. In addition, by switching the control method of the valve controller 4 to digital control, manufacturing costs of the whole of the device can be reduced.

A second embodiment is described below. Note that parts corresponding to those in the first embodiment are added with the same symbols.

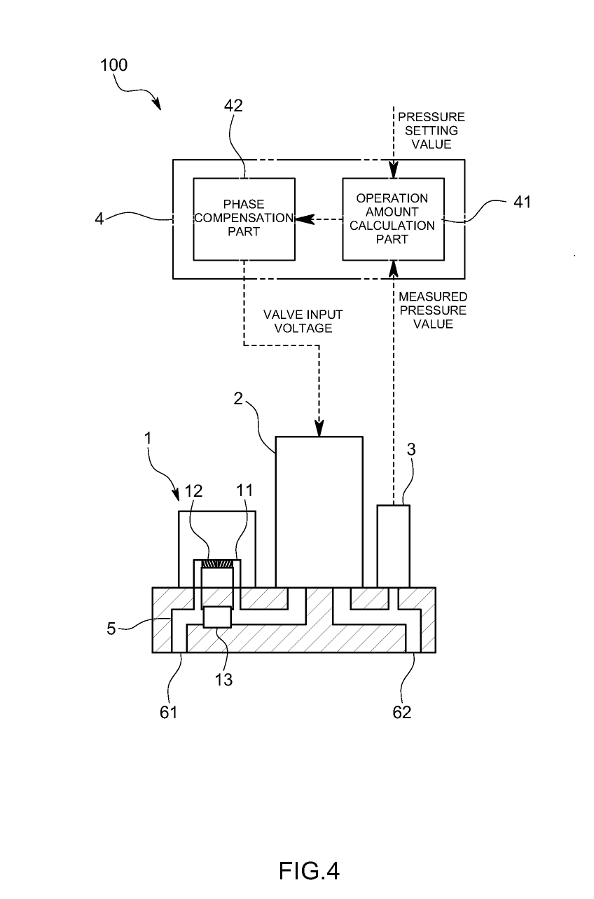

The fluid control device 100 of the above-described embodiment is one configured to control a flow rate; however, the present invention may be configured to control another physical quantity such as pressure. That is, to describe the case where the above-described fluid control device 100 is a pressure control device, in the above-described embodiment, the flow rate sensor 1 corresponds to the fluid measurement part in the claims; however, as illustrated in FIG. 4, in the present embodiment, the pressure sensor 3 corresponds to the fluid measurement part in claims. Also, along with this, the configuration of the valve controller 4 is also different. In the present embodiment, an order in which the respective sensors and valve are arranged along the flow path 5 is also changed, and they are provided in the order of the flow rate sensor 1, the flow rate control valve 2, and the pressure sensor 3. This is because a value close to pressure inside a chamber connected subsequently is measured to control a pressure amount in the stage subsequent to the pressure control device to an adequate value. In addition, the flow rate sensor 1 is used, for example, to check whether or not the fluid flows in the pressure control device, or for another purpose.

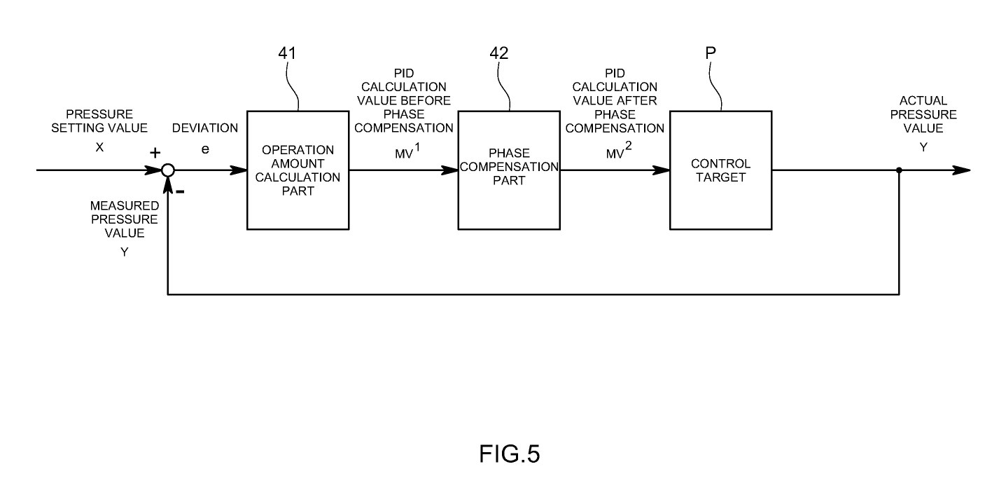

To more specifically describe the fluid control device 100, the valve controller 4 is configured to control the fluid control valve 2 such that a measured pressure value measured by the pressure sensor 3 becomes equal to a pressure setting value that is preliminarily set. The operation amount calculation part 41 in the valve controller 4 is configured to perform a PID calculation on a deviation between the measured pressure value and the setting value to thereby calculate an operation amount for an opening level of the fluid control valve 2. Further, the phase compensation part 42 is configured to input as a feedback value to the fluid control valve 2 a value obtained, with use of velocity type digital calculation, by making phase compensation for the opening level operation amount calculated by the operation amount calculation part 41. Note that, in the second embodiment, calculation expressions for control used in the valve controller 4 are the same except that the control target is changed from a flow rate to pressure, and a corresponding block diagram is as illustrated in FIG. 5. Even in the case of configuring the fluid control device to be such a pressure control device, almost the same responsiveness as in the case where the control method of the valve controller 4 is based on analog control can be achieved, and also by switching from analog control to digital control, manufacturing costs can be reduced.

Other embodiments are described.

In any of the above-described embodiments, as an example of fluid, gas that is a compressible fluid is used as the control target; however, for example, incompressible liquid may be used as the control target. In the case of using liquid as the control target, the responsiveness of fluid control can be further improved.

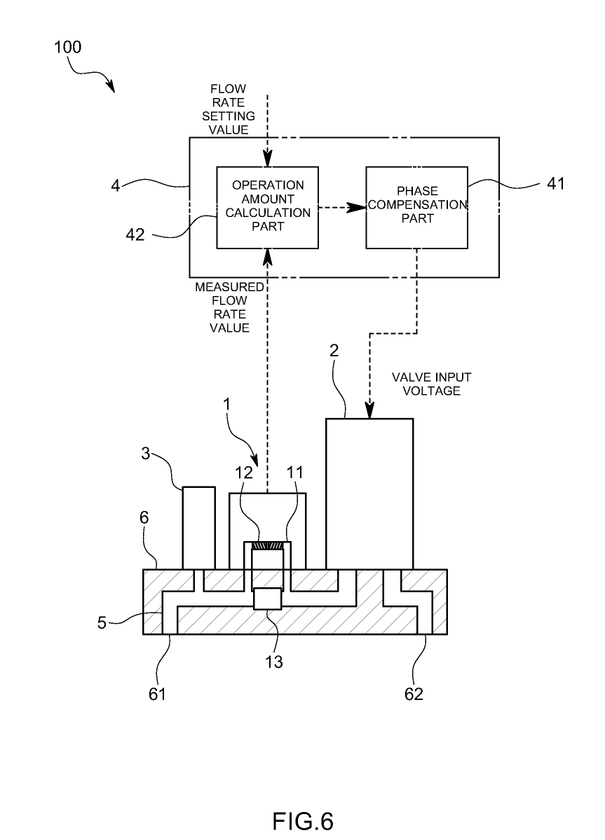

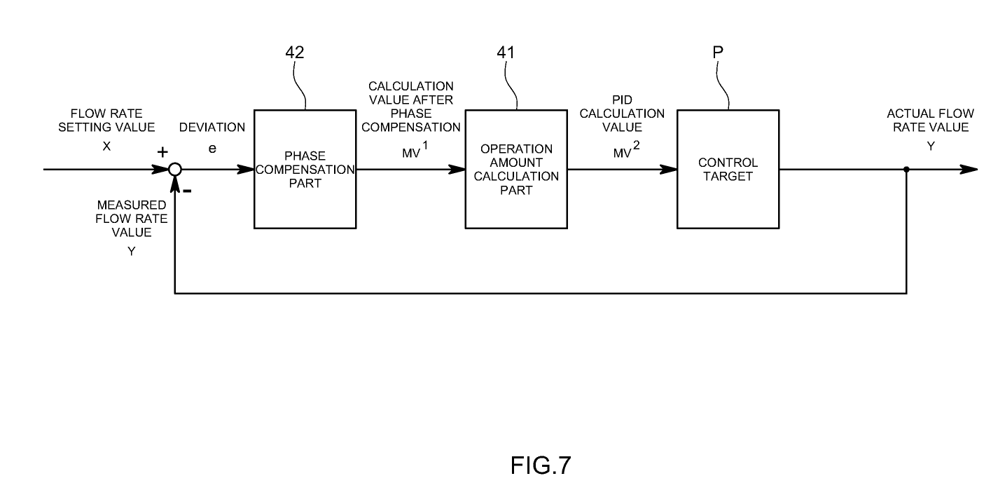

Also, the configuration of the valve controller 4 described in each of the embodiments may be variously modified. For example, the operation amount calculation part 41 may calculate the operation amount by a method other than the PID calculation, such as PI calculation. Further, a method for the digital calculation in the operation amount calculation part 41 may be velocity type digital calculation or position type digital calculation. Still further, the control signal is processed in the order of the operation amount calculation part 41 and the phase compensation part 42, but, as illustrated in FIGS. 6 and 7, may be processed in the reverse order. That is, in this embodiment, a value to be inputted to the operation amount calculation part 41 is not the deviation but a value after phase compensation, and a value to be inputted to the phase compensation part 42 is not the value after the PID calculation but the deviation. That is, values to be inputted to the operation calculation part 41 and the phase compensation part 42 are not limited to some specific values, respectively. In addition, in the case of such a configuration, regarding the operation amount calculation part 41, it is only necessary to respectively replace e and MV¹ in Expressions 2 and 3 with MV¹ and MV² for use, and also regarding the phase compensation part 42, it is only necessary to respectively replace MV¹ and MV² in Expressions 5 and 6 with e and MV¹ for use. In short, it is only necessary to be an equivalent control block in a block diagram or the like, and for example, the phase compensation part 42 may be configured to act as an element that acts in the feedback loop.

Also, an order in which the respective sensors and valve of the mass flow controller are arranged is not limited to any of those described in the above embodiments, but may be changed depending on the intended use such as control. For example, in the first embodiment, from the upstream side, the flow rate sensor 1, the pressure sensor 3, and the flow rate control valve 2 may be provided in this order. In addition, on the basis of the measured pressure value outputted from the pressure sensor 3, the measured flow rate value, deviation, flow rate setting value may be corrected to further improve the responsiveness of the fluid control device. In particular, to describe the correction of the measured flow rate value outputted from the flow rate sensor 1, the flow rate calculation part may be configured to correct, on the basis of the pressure value indicated by the pressure sensor 3, a time variation of the pressure value, the flow rate setting value that has been set, and the like, the flow rate value calculated on the basis of the voltage values obtained from the respective coils 12, and then output the resultant value outside as the measured flow rate value.

In any of the above-described embodiments, the fluid control valve, the fluid measurement part, and the valve controller are packaged into the one mass flow controller, but may not be packaged. For example, only the valve controller may be configured to be a separate body with use of a general purpose computer, such as a personal computer.

In the following, a third embodiment of the present invention is described with reference to the drawings. Note that, in the drawings used to describe the following third embodiment, symbols are added independently of those in the drawings used to describe the first and second embodiments.

A pressure control device 100 of the present embodiment is one that is, in a semiconductor manufacturing apparatus, used to introduce any of various types of gases at a desired pressure into a chamber where deposition or etching is performed. To more specifically describe this, the pressure control device 100 is one that is used to maintain the pressure of helium gas introduced to the chamber as a cooling constant to improve cooling efficiency of the gas. More specifically, the pressure control device 100 is one that is connected to each of pipes connected to the chamber, and controls corresponding gas flowing through the pipe as the flow path 5.

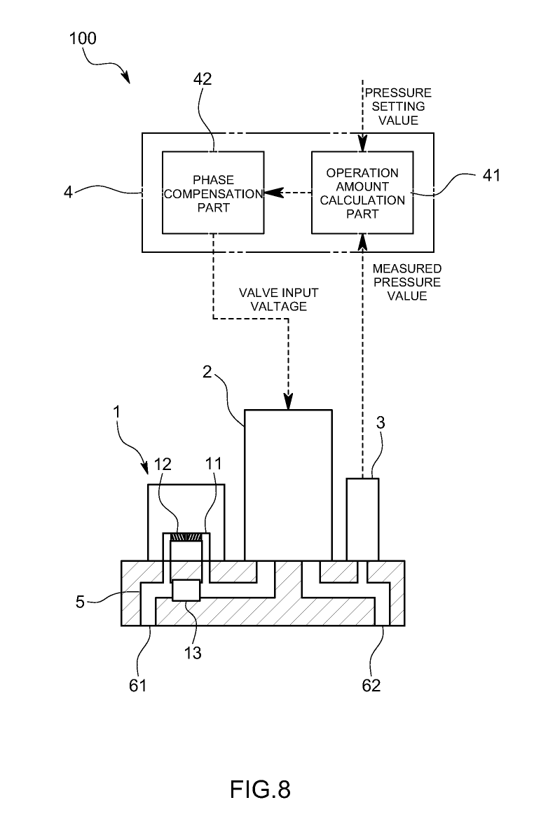

The pressure control device 100 is, as illustrated in FIG. 8, provided with: the body 6 inside which the flow path 5 is formed; the flow rate sensor 1, the fluid control valve 2, and the pressure sensor 3 which are sequentially provided from an upstream side of the flow path 5; and the valve controller 4 configured to control, on the basis of output of the flow rate sensor 1 or the pressure sensor 3, an opening level of the fluid control valve 2, in which the respective parts are packaged as one casing. In addition, in the present embodiment, fluid serving as a control target is a gas such as helium; however, the present invention can also be applied to other gases used for semiconductor manufacturing.

Each of the parts is described below.

The body 6 is a block body having a substantially rectangular parallelepiped shape, inside which a penetration path is formed to thereby form the internal flow path 5 through which the fluid flows. On a bottom surface of the body 6, the introduction port 61 that is a start point of the internal flow path 5, and the lead-out port 62 that is an end point are provided. The introduction port 61 and the lead-out port 62 are used while being connected to connection ports of a gas panel (not illustrated) which is used in a semiconductor manufacturing process or the like in place of pipes or the like, and has flow paths inside. Also, an upper surface of the body 6 is attached with the flow rate sensor 1, the fluid control valve 2, and the pressure sensor 3 to thereby provide the respective sensors and valve on the flow path 5.

The flow rate sensor 1 is one configured to measure a flow rate that is a physical quantity of the fluid flowing through the internal flow path 5, and a so-called thermal flow rate sensor. The flow rate sensor is one that is provided with: a sensor flow path 11 that is formed by a narrow tube so as to branch from the internal flow path 5 and join the flow path 5 again; a pair of coils 12 that is provided on an outer circumference of the narrow tube; and the laminar flow element 13 that is provided in the internal flow path 5 between a branch point and junction point of the sensor flow path 11. Also, the flow rate sensor 1 is configured such that voltages are applied to the two coils 12; control is performed such that the respective coils keep a constant temperature at the same temperature; and on the basis of the respective voltages applied at the time, an unillustrated flow rate calculation part calculates a mass flow rate of the fluid flowing through the flow path 5. Note that, in the present embodiment, the thermal flow rate sensor 1 is one configured to measure a mass flow rate, but may be configured to output a volume flow rate. Also, in the present embodiment, the flow rate sensor 1 is not directly used for pressure control, but may be used to, for example, check whether or not the fluid flows through the flow path 5 without stagnating, or for another purpose. Further, the flow rate sensor 1 is not limited to the thermal flow rate sensor 1, but may be, for example, the differential pressure flow rate sensor 1. In addition, the laminar flow element 13 may be a flow path resistor such as an orifice.

The fluid control valve 2 is a solenoid valve, and is adapted to be able to adjust the opening level thereof by moving an unillustrated valve element with an electromagnetic force. In the case of the solenoid valve, initial response speed is high, and therefore the responsiveness of fluid control can be improved. The fluid control valve 2 is not limited to the solenoid valve as well, but may be any other valve having a low response speed, as compared with the solenoid valve, such as a piezo valve if the responsiveness of fluid control is allowed to be slightly damaged.

The pressure sensor 3 is adapted to be able to measure pressure inside the subsequent chamber by being provided in a stage subsequent to the fluid control valve 2.

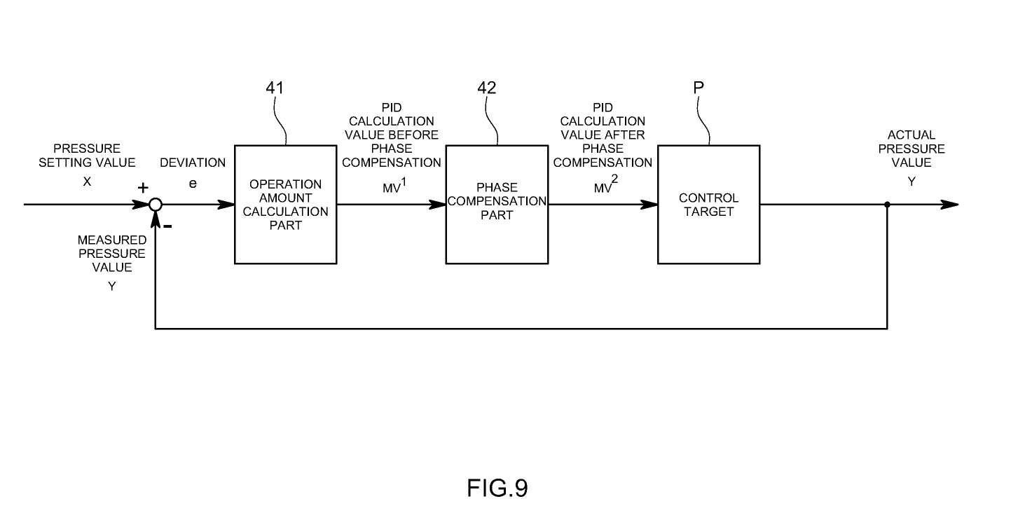

The valve controller 4 is one configured to control the opening level of the fluid control valve 2 by digital control such that a measured pressure value that is measured by the pressure sensor 3 becomes equal to a setting value that is preliminarily set. More specifically, the valve controller 4 is one that uses a so-called computer having a CPU, a memory, an AC/DC converter, and the like to execute various types of programs stored in the memory by use of the CPU, and thereby realizes the aforementioned function. Also, the valve controller 4 is configured to fulfill functions as at least the operation amount calculation part 41 and the phase compensation part 42. In other words, the valve controller 4 is configured not to be a controller with an analog circuit such as an operational amplifier, but to be a digital controller that realizes the control function with the programs, and is configured to return the feedback value to the fluid control valve 2 every control period. In addition, the valve controller 4 is configured such that, under the condition that input is the pressure setting value and output is the measured pressure value, a block diagram representing a transfer function from the setting value to the measured value is one as illustrated in FIG. 9. Note that a block in which “Control target P” is described in the block diagram represents a transfer function that is described on the basis of characteristics of the fluid control valve 2, characteristics of the fluid, sensor characteristics, and the like of the mass flow controller.

The operation amount calculation part 41 is one configured to perform a predetermined calculation on an inputted value to output a value related to an operation amount for the opening level of the fluid control valve. That is, the operation amount calculation part 41 is configured to be inputted with a deviation between the measured pressure value that is measured by the pressure sensor 3, and the setting value that is preliminarily set to calculate the operation amount for the opening level of the fluid control valve 2 by PID calculation, and output the resultant output value to the phase compensation part 42. More specifically, the operation amount calculation part 41 has control characteristics corresponding to a calculation expression represented by Expression 10 in a time domain representation in analog control.

$${MV}^{1} = {K}_{p} ( e + \frac{1}{{T}_{I}} \int e d i + {T}_{D} \frac{d e}{d t} ) \qquad [ Expression 10 ]$$

where e is the deviation between the measured value and the setting value; MV¹ is a PID calculation value; Kp is a proportional gain; T_{I} is an integration time; and T_{D} is a derivative time.

In the present embodiment, digital control is used, and therefore the operation amount calculation part 41 performs the calculation on the basis of Expressions 11 and 12, which are converted from Expression 10, so as to calculate the PID calculation value MV¹ by velocity type digital calculation.

MVₙ¹=MVₙ₋₁¹+ΔMVₙ¹ [Expression 11]

$$Δ {MV}_{n}^{1} = {K}_{p} \{ ( {e}_{n} - {e}_{n - 1} ) + \frac{Δ t}{{T}_{I}} {e}_{n} + \frac{{T}_{D}}{Δ t} ( {e}_{n} - 2 {e}_{n - 1} + {e}_{n - 1} ) \} \qquad [ Expression 12 ]$$

where Δt is a length of a control period; MV¹ₙ is a PID calculation value in an n-th control period; and ΔMV¹ₙ is a difference between the PID calculation value in the n-th control period and a PID calculation value in an (n−1)-th control period.

That is, as can be seen from Expressions 11 and 12, the operation amount calculation part 41 does not calculate an output value every time, but is configured to calculate only a variation from a previous output value and add that variation to the previous output value to calculate a present output value.

The phase compensation part 42 is one configured to output a value obtained by compensating an inputted value for a phase shift by velocity type digital calculation, and in the present embodiment, configured to output for a phase delay. The phase compensation part 42 is configured to compensate the PID calculation value inputted from the operation amount calculation part 41 for the phase delay by velocity type digital calculation, and input a voltage corresponding to the resultant value to the fluid control valve 2 as the feedback value. Corresponding control characteristics correspond to a calculation expression represented by Expression 13 in the time domain representation in analog control.

$${MV}^{2} = {MV}^{1} + C \frac{d {MV}^{ 1}}{d t} \qquad [ Expression 13 ]$$

where MV² is a PID calculation value after the phase compensation; and C is a phase compensation factor.

In the present embodiment, digital control is used, and therefore the operation amount calculation part 41 performs the calculation on the basis of Expressions 14 and 15, which are converted from Expression 13, so as to output a value after the phase compensation by velocity type digital calculation.

MVₙ²=MVₙ₋₁²+ΔMVₙ² [Expression 14]

$$Δ {MV}_{n}^{2} = {MV}_{n}^{1} - {MV}_{n - 1}^{1} + \frac{C}{Δ t} ( {MV}_{n}^{1} - 2 {MV}_{n - 1}^{1} + {MV}_{n - 2}^{1} ) \qquad [ Expression 15 ]$$

where Δt is the length of the control period; MV¹ₙ is the PID calculation value before the phase compensation in the n-th control period; MV²ₙ is a PID calculation value after the phase compensation in the n-th control period; and ΔMV²ₙ is a difference between the PID calculation value after the phase compensation in the n-th control period and a PID calculation value after the phase compensation in an (n−1)-th control period.

Note that, for ease of comprehension, the operation amount calculation part 41 and the phase compensation part 42 are described as performing the calculations based on exact differentials; however, in order to further improve the responsiveness, in the flowing description, for example, by replacing Expression 12 with Expression 16, and Expression 15 with Expression 17, the operation amount calculation part 41 and the phase compensation part 42 perform calculations with use of inexact differentials as described below. In addition, they may perform the calculations with use of the exact differentials depending on the intended purpose such as control, or allowable error.

$$\begin{matrix}Δ {MV}_{n}^{1} = {K}_{p} \{ ( {e}_{n} - {e}_{n - 1} ) + \frac{Δ t}{{T}_{I}} {e}_{n} + \frac{{T}_{D}}{Δ t} ( {e}_{n} - 2 {e}_{n - 1} + {e}_{n - 1} ) \} ⇒ Δ {MV}_{n}^{1} = {K}_{p} \{ ( {e}_{n} - {e}_{n - 1} ) + \frac{Δ t}{{T}_{I}} {e}_{n} + Δ {d}_{n}^{1} \} \\ Δ {d}_{n}^{1} = \{ \frac{{η}_{1} {T}_{D}}{Δ t + {η}_{1} {T}_{D}} Δ {d}_{n - 1}^{1} + \frac{{T}_{D}}{Δ t + {η}_{1} {T}_{D}} ( {e}_{n} - 2 {e}_{n - 1} + {e}_{n - 1} ) \} & [ Expression 16 ] \\ Δ {MV}_{n}^{2} = {MV}_{n}^{1} - {MV}_{n - 1}^{1} + \frac{C}{Δ t} ( {MV}_{n}^{1} - 2 {MV}_{n - 1}^{1} + {MV}_{n - 2}^{1} ) ⇒ Δ {MV}_{n}^{2} = {MV}_{n}^{1} - {MV}_{n - 1}^{1} + Δ {d}_{n}^{2} \\ Δ {d}_{n}^{2} = \{ \frac{{η}_{2} C}{Δ t + {η}_{2} C} Δ {d}_{n - 1}^{2} + \frac{C}{Δ t + {η}_{2} C} ( {MV}_{n}^{1} - 2 {MV}_{n - 1}^{1} + {MV}_{n - 2}^{1} ) \} & [ Expression 17 ]\end{matrix}$$

where η₁ and η₂ are time constants.

Next, the responsiveness of the pressure control device 100 of the present embodiment is described.

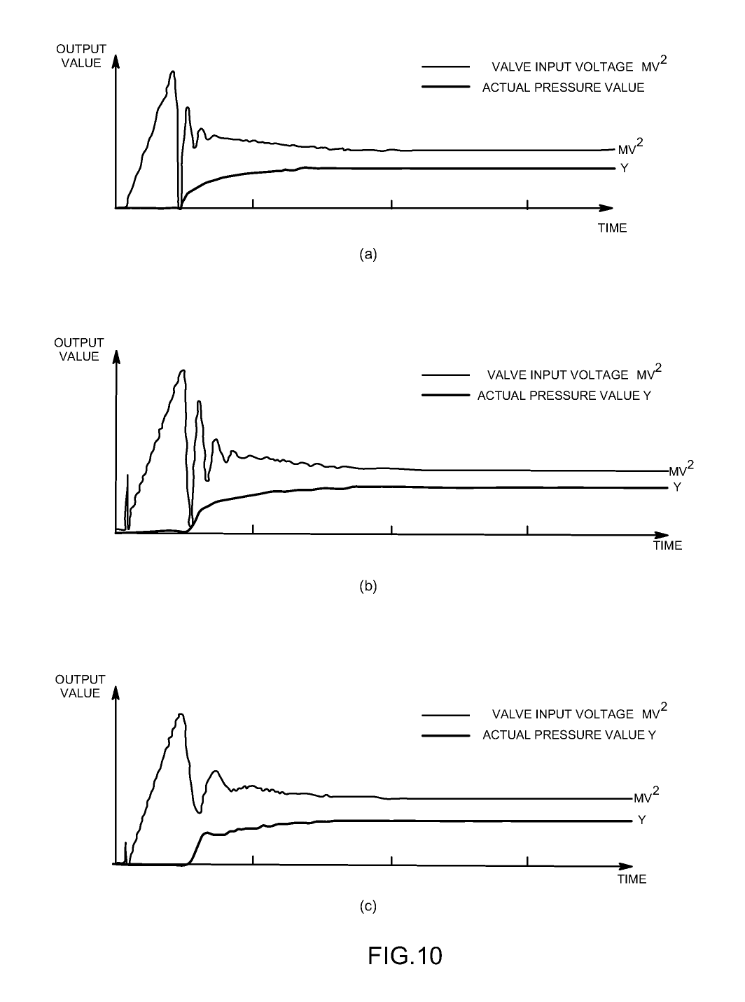

FIGS. 10(a), (b), and (c) respectively illustrate measurement results of: a step response of the pressure control device 100 in which the phase compensation part 42 is configured with use of a conventional analog circuit; a step response of the pressure control device 100 of the present embodiment, in which, as described above, the phase compensation part 42 is configured to compensate for the phase delay by velocity type digital calculation; and a step response of the pressure control device 100 in which the phase compensation part 42 is configured to compensate for the phase delay by position type digital calculation. In addition, a thin solid line represents a variation in voltage value corresponding to the feedback value inputted from the phase compensation part 42 to the fluid control valve 2, and a thick solid line represents a measured pressure value that corresponds to an output value of a corresponding control system and is measured by the pressure sensor 3.

As is clear from a comparison between FIGS. 10.(a) and (b), it turns out that even in digital control as in the present embodiment, in the case of compensating for the phase delay by velocity type digital calculation, substantially the same responsiveness as in the conventional analog control case can be achieved.

On the other hand, as illustrated in FIG. 10(c), in the case of making the phase compensation by the position type digital calculation expressed by Expression 18, which is different from the present embodiment, a voltage waveform applied to the fluid control valve 2 and a waveform of the measured flow rate value are both different from those in the analog control case. In particular, regarding the measured pressure value, slight overshoot occurs in a rise portion, and the same responsiveness as in the analog control case cannot be achieved.

$${MV}_{n}^{2} = {MV}_{n}^{1} - {MV}_{n - 1}^{1} + \frac{C}{Δ t} ( {MV}_{n}^{1} - {MV}_{n - 1}^{1} ) \qquad [ Expression 18 ]$$

As illustrated in the diagrams, it is expected that the reason why the difference in responsiveness arises between the position type digital control and velocity type digital control is because the control target is gas, and a pressure value nonlinearly varies with respect to a variation in opening level of the fluid control valve 2, or the opening level of the fluid control valve 2 itself also nonlinearly varies with respect to a variation in input voltage, which causes the occurrence of noise influence, so that velocity type digital calculation has a configuration that is resistant to such noise similarly to the conventional analog control case.

As described, the present inventors have found, as a result of trial and error based on the above-described measure experiment and the like, that it is only necessary to configure the phase compensation part 42 to compensate for the phase delay by velocity type digital calculation, and thereby the pressure control device 100 of the present embodiment can achieve the same responsiveness as in the conventional analog control case. In addition, by switching the control method of the valve controller 4 to digital control, manufacturing costs of the whole of the device can be reduced.

Other embodiments are described below. Note that parts corresponding to those in the third embodiment are added with the same symbols.

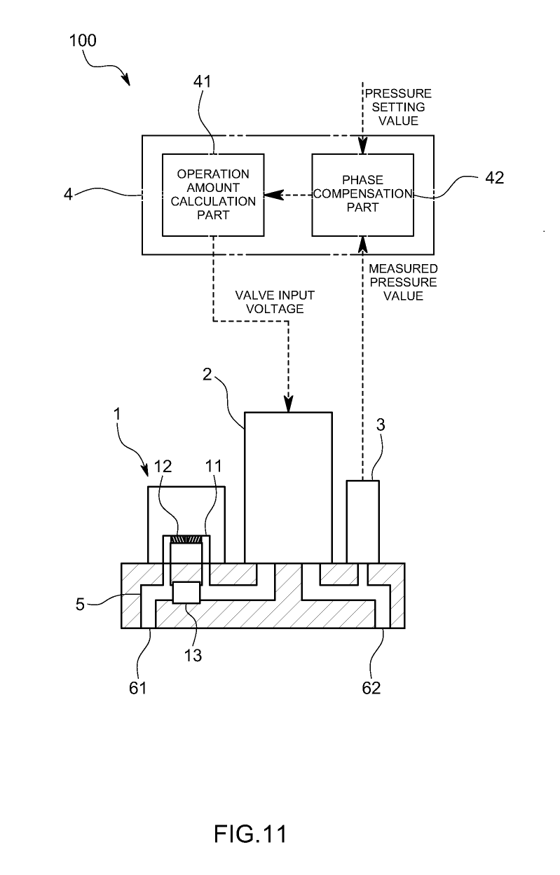

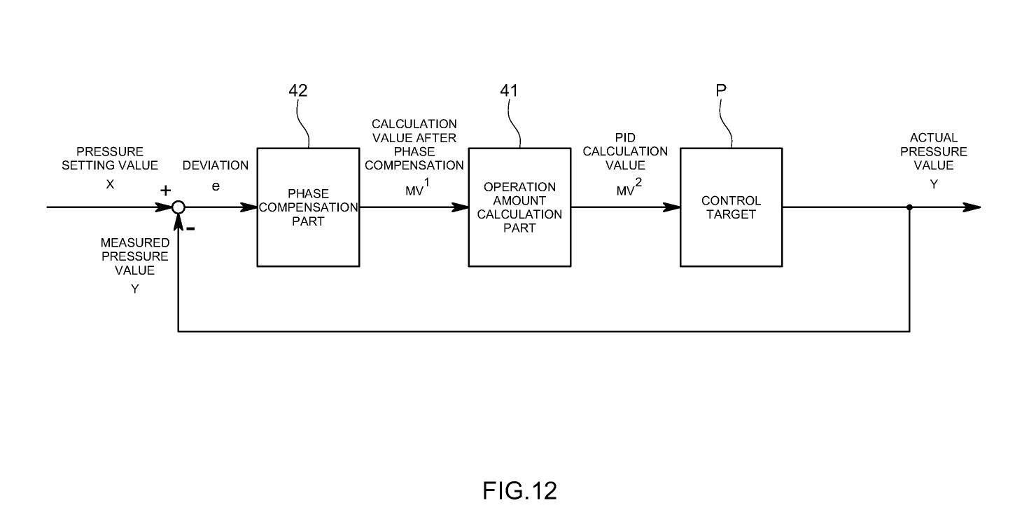

In the above-described third embodiment, a control signal is processed in the order of the operation amount calculation part 41 and the phase compensation part 42, but, as illustrated in FIGS. 11 and 12, may be processed in the reverse order. In addition, in the case of such a configuration, regarding the operation amount calculation part 41, it is only necessary to respectively replace e and MV¹ in Expressions 11 and 12 with MV¹ and MV² for use, and also, regarding the phase compensation part 42, it is only necessary to respectively replace MV¹ and MV² in Expressions 14 and 15 with e and MV¹ for use. In short, it is only necessary to be an equivalent control block in a block diagram or the like, and for example, the phase compensation part 42 may be configured to act as an element that acts in the feedback loop. Also, an order in which the respective sensors and valve of the mass flow controller are arranged is not limited to any of those described in the above embodiments, but may be changed depending on the intended use, such as control.

In any of the above-described embodiments, as an example of fluid, gas that is a compressible fluid is used as the control target; however, for example, incompressible liquid may be used as the control target.

Also, the configuration of the valve controller 4 described in each of the embodiments may be variously modified. For example, the operation amount calculation part 41 may calculate the operation amount by a method other than the PID calculation, such as PI calculation. Further, a method for the digital calculation in the operation amount calculation part 41 may be based on velocity type digital calculation or position type digital calculation.

In the above-described embodiment, the fluid control valve, the pressure sensor, and the valve controller are packaged into the one pressure control device, but may not be packaged. For example, only the valve controller may be configured to be a separate body with use of a general purpose computer, such as a personal computer.

In the following, a fourth embodiment of the present invention is described with reference to the drawings. Note that symbols indicated in the drawings used to describe the fourth embodiment are added independently of those indicated in the drawings used to describe the first through third embodiments.

The fluid control device 100 of the fourth embodiment is one that is, in a semiconductor manufacturing apparatus, used to introduce any of various types of gases at a desired flow rate or pressure into a chamber where deposition or etching is performed. More specifically, the fluid control device 100 is connected to each of pipes connected to the chamber, and controls corresponding gas flowing through the pipe as the flow path 5.

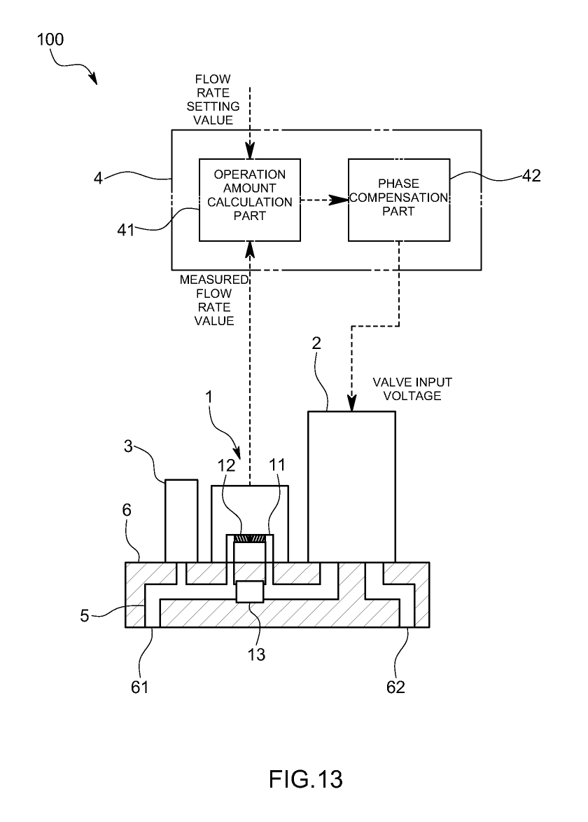

The fluid control device 100 is a so-called mass flow controller, and, as illustrated in FIG. 13, is provided with: the body 6 inside which the flow path 5 is formed; the pressure sensor 3, the flow rate sensor 1, and the fluid control valve 2 which are sequentially provided from an upstream side of the flow path 5; and a valve control mechanism 4 configured to control, on the basis of output of the flow rate sensor 1 or the pressure sensor 3, an opening level of the fluid control valve 2, in which the respective parts are packaged as one casing. In addition, in the present embodiment, fluid serving as a control target is a gas such as helium; however, the present invention can also be applied to other gases used for semiconductor manufacturing.

Each of the parts is described below.

The body 6 is a block body having a substantially rectangular parallelepiped shape, inside which a penetration path is formed to thereby form the flow path 5 through which the fluid flows. On a bottom surface of the body 6, the introduction port 61 that is a start point of the flow path 5, and the lead-out port 62 that is an end point are provided. The introduction port 61 and lead-out port 62 are used while being connected to connection ports of a gas panel (not illustrated) which is used in a semiconductor manufacturing process or the like in place of pipes or the like and has flow paths inside. Also, an upper surface of the body 6 is attached with the pressure sensor 3, the flow rate sensor 1, and the fluid control valve 2 to thereby provide the respective sensors and valve on the flow path 5.

The pressure sensor 3 is one that is intended to measure primary side pressure that is pressure on an upstream side of the fluid control valve 2. A pressure value detected by the pressure sensor 3 is used for operation check of various types of devices, or the like.

The fluid control valve 2 is a solenoid valve, and adapted to be able to adjust the opening level thereof by moving an unillustrated valve element with electromagnetic force. The fluid control valve 2 is not limited to the solenoid valve as well, but may be any other valve such as a piezo valve.

The flow rate sensor 1 is one configured to measure a flow rate that is a physical quantity of the fluid flowing through the flow path 5, and a so-called thermal flow rate sensor. The flow rate sensor 1 is one that is provided with: a sensor flow path 1 that is formed by a narrow tube so as to branch from the flow path 5 and join the flow path 5 again; a pair of coils 12 that are provided on an outer circumference of the narrow tube; and the laminar flow element 13 that is provided in the flow path 5 between a branch point and a junction point of the sensor flow path 11. Also, the flow rate sensor 1 is configured such that voltages are applied to the two coils 12; control is performed such that the respective coils keep a constant temperature at the same temperature; and on the basis of the respective voltages applied at the time, an unillustrated flow rate calculation part calculates a mass flow rate of the fluid flowing through a flow path 5. Note that, in the present embodiment, the thermal flow rate sensor 1 is one configured to measure a mass flow rate, but may also be configured to output a volume flow rate. Also, the flow rate sensor 1 is not limited to the thermal flow rate sensor, but may be, for example, a differential pressure flow rate sensor. In the case of using the differential pressure flow rate sensor as described above, the response speed of the sensor output with respect to a flow rate change can be improved to further improve the responsiveness of fluid control. In addition, the laminar flow element 13 may be a flow path resistor such as an orifice.

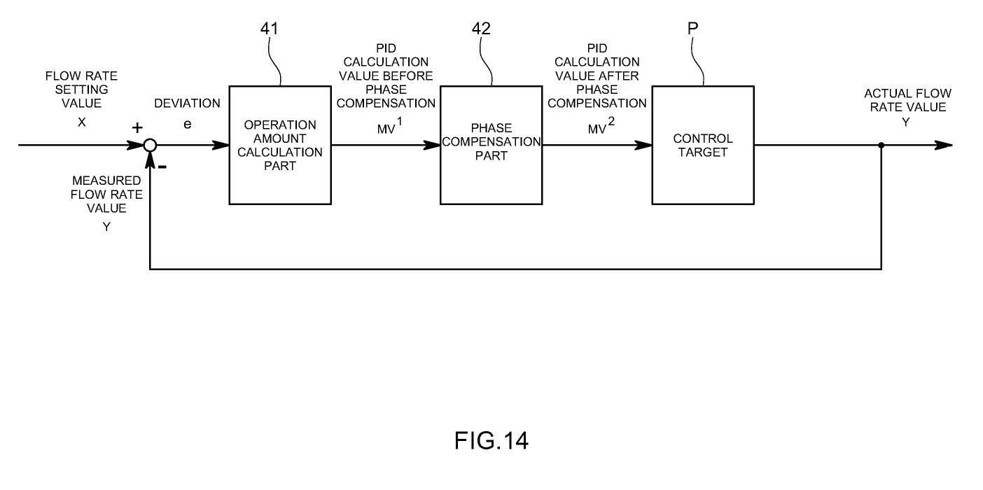

The valve control mechanism 4 is one configured to control the opening level of the fluid control valve 2 by a hybrid of digital control and analog control such that a measured flow rate value that is measured by the flow rate sensor 1 becomes equal to a setting value that is preliminarily set. More specifically, the valve control mechanism 4 can be divided into two regions in a hardware manner, and the first region is configured to realize a function as the operation amount calculation part 41 by using a so-called computer having a CPU, a memory, an AC/DC converter, and the like to execute various types of programs stored in the memory with use of the CPU. On the other hand, the second region is configured with use of an analog circuit, and adapted to realize a function as the phase compensation part 42. Also, the valve control mechanism 4 is configured such that, under the condition that input is the flow rate setting value and output is the measured flow rate value, a block diagram representing a transfer function from the setting value to the measured value is as illustrated in FIG. 14. Note that the block in which “Control target” is described in the block diagram represents a transfer function that is described on the basis of characteristics of the fluid control valve 2, characteristics of the fluid, sensor characteristics, and the like of the mass flow controller.

The operation amount calculation part 41 is a digital controller configured to perform a predetermined calculation on an inputted value to output a value related to an operation amount for the opening level of the fluid control valve. The operation amount calculation part 41 is configured to be inputted with a deviation between the measured flow rate value that is measured by the flow rate sensor 1 and the setting value that is preliminarily set to calculate the operation amount for the opening level of the fluid control valve 2 by PID calculation, and output the resultant output value to the phase compensation part 42. That is, the operation amount calculation part 41 discretely outputs a PID calculation value to the phase compensation part 42 every predetermined control period. More specifically, the operation amount calculation part 41 has control characteristics corresponding to a calculation expression represented by Expression 19 in a time domain representation in analog control.

$${MV}^{1} = {K}_{p} ( e + \frac{1}{{T}_{I}} \int e d t + {T}_{D} \frac{d e}{d t} ) \qquad [ Expression 19 ]$$

where e is the deviation between the measured value and the setting value; MV¹ is the PID calculation value; Kp is a proportional gain; T_{I} is an integration time; and T_{D} is a derivative time.

In the present embodiment, digital control is used, and therefore the operation amount calculation part 41 performs the calculation on the basis of Expressions 20 and 21, which are converted from Expression 19, so as to calculate the PID calculation value MV¹ by velocity type digital calculation.

MVₙ¹=MVₙ₋₁¹+ΔMVₙ¹ [Expression 20]

$$Δ {MV}_{n}^{1} = {K}_{p} \{ ( {e}_{n} - {e}_{n - 1} ) + \frac{Δ t}{{T}_{I}} {e}_{n} + \frac{{T}_{D}}{Δ t} ( {e}_{n} - 2 {e}_{n - 1} + {e}_{n - 1} ) \} \qquad [ Expression 21 ]$$

where Δt is a length of the control period; MV¹ₙ is a PID calculation value in an n-th control period; and ΔMV¹ₙ is a difference between the PID calculation value in the n-th control period and a PID calculation value in an (n−1)-th control period.

That is, as can be seen from Expressions 20 and 21, the operation amount calculation part 41 does not calculate an output value every time, but is configured to calculate only a variation from a previous output value and add the variation to the previous output value to calculate a present output value.

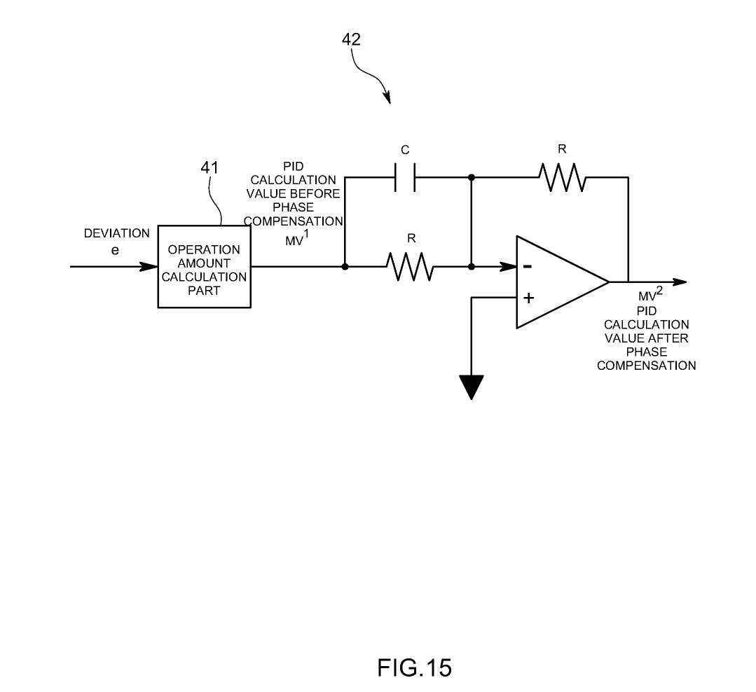

The phase compensation part 42 is configured to compensate the PID calculation value inputted from the operation amount calculation part 41 for a phase delay by an analog circuit illustrated in a circuit diagram of FIG. 15, and input a voltage corresponding to the resultant value to the fluid control valve 2 as a feedback value. More specifically, the analog circuit constituting the operation amount calculation part 41 is one in which an input resistance part of an inverting amplifier circuit is replaced by a parallel circuit of a resistor and a capacitor, and control characteristics thereof correspond to a calculation expression represented by Expression 22 in the time domain representation in analog control.

$${MV}^{2} = {MV}^{1} + RC \frac{d {MV}^{1}}{d t} \qquad [ Expression 22 ]$$

where MV² is a PID calculation value after the phase compensation; C is a capacitance value of the capacitor; and R is a resistance value of each of resistors.

Next, the responsiveness of the fluid control device 100 of the present embodiment is described with use of the simulation results. In addition, in the simulations, an exact differential is replaced by an inexact differential. A circuit of the phase compensation part is configured to further add a resistor to the capacitor in series. Regarding the exact and inexact differentials, any of them may be used depending on required accuracy or the like.

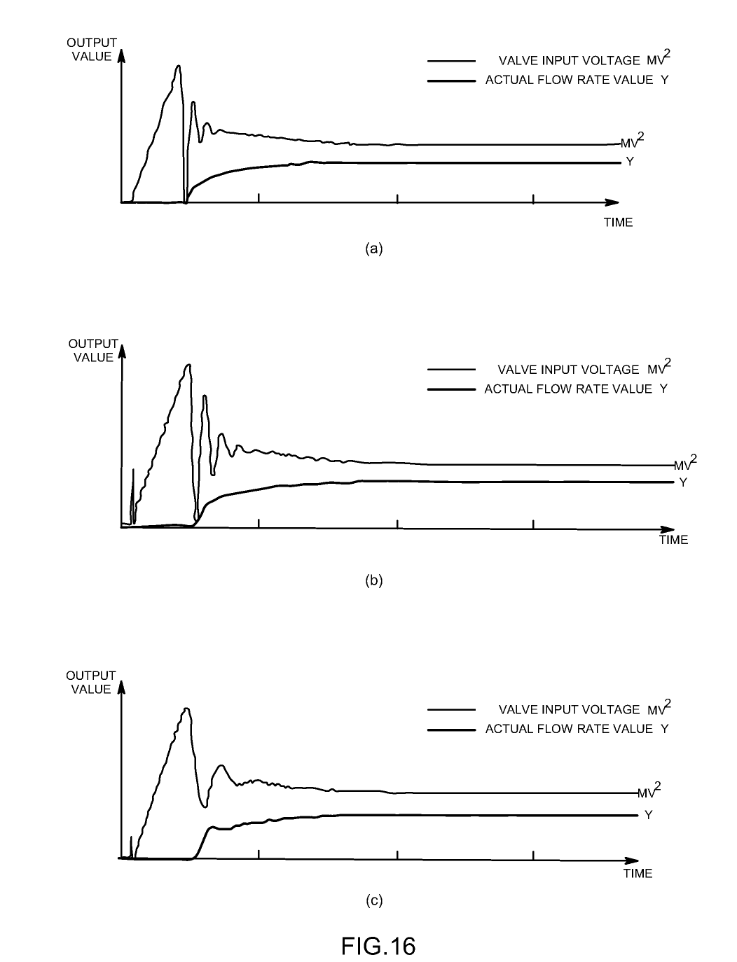

FIGS. 16(a), (b), and (c) respectively illustrate: a step response of the fluid control device 100 in which the phase compensation part 42 is configured with use of a conventional analog circuit; a step response of the fluid control device 100 of the present embodiment, in which as described above, the operation amount calculation part 41 uses digital control, and the phase compensation part 42 is configured to compensate for the phase delay by analog control; and a step response of the fluid control device in which both of the operation amount calculation part 41 and the phase compensation part 42 use digital control. In addition, a thin solid line represents a variation in voltage value corresponding to the feedback value inputted from the phase compensation part 42 to the fluid control valve 2, and a thick solid line represents a measured flow rate value that corresponds to an output value of a corresponding control system and is measured by the flow rate sensor 1.

As is clear from a comparison between FIGS. 16(a) and (b), it turns out that, as in the present embodiment, in the case where digital control is used for the operation amount calculation part 41 and the phase compensation part 42 configured to compensate for the phase delay by analog control, substantially the same responsiveness as in the conventional analog control case can be achieved.

On the other hand, as illustrated in FIG. 16(c), in the case of making the phase compensation by digital control, which is different from the present embodiment, a voltage waveform applied to the fluid control valve 2 and a waveform of the measured flow rate value are both different from those in the analog control case. In particular, regarding the measured flow rate value, slight overshoot occurs in a rise portion, and the same responsiveness as in the analog control case cannot be achieved.

As illustrated in the diagrams, it is expected that the reason why the difference in responsiveness arises depending on whether digital control or analog control is used for the phase compensation part 42 is because the control target is gas, and a flow rate nonlinearly varies with respect to a variation in opening level of the fluid control valve 2, or the opening level of the fluid control valve 2 itself also nonlinearly varies with respect to a variation in input voltage, which causes the occurrence of noise influence, so that the phase compensation part 42 is configured with use of the analog circuit to thereby have a configuration resistant to noise.

As described above, the present inventors have found as a result of trial and error based on the above-described measure experiments and the like that it is only necessary to configure the operation amount calculation part 41 to use digital control, and also configure the phase compensation part 42 with use of the analog circuit to compensate for the phase delay by analog control, and thereby the fluid control device 100 of the present embodiment can achieve the same responsiveness as in the conventional analog control case. In addition, by switching the control method of the operation amount calculation part 41 to digital control, manufacturing costs of the whole of the device can be reduced.

A fifth embodiment is described below. Note that parts corresponding to those in the fourth embodiment are added with the same symbols.

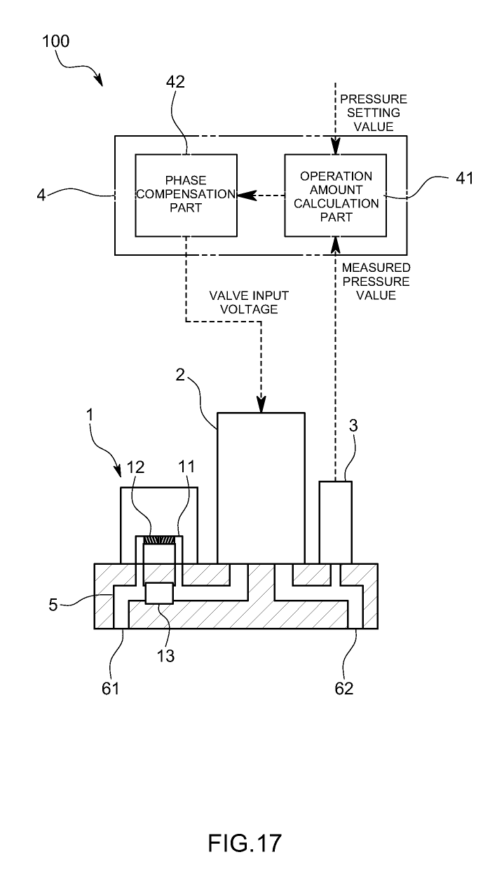

The fluid control device 100 of the fourth embodiment is one configured to control a flow rate; however, the present invention may be configured to control another physical quantity such as pressure. That is, to describe a case where the above-described fluid control device 100 is a pressure control device, in the fourth embodiment, the thermal flow rate sensor 1 corresponds to the fluid measurement part in the claims; however, as illustrated in FIG. 17, in the fifth embodiment, the above-described pressure sensor 3 corresponds to the fluid measurement part in claims. Further, along with this, the configuration of the valve control mechanism 4 is also different.

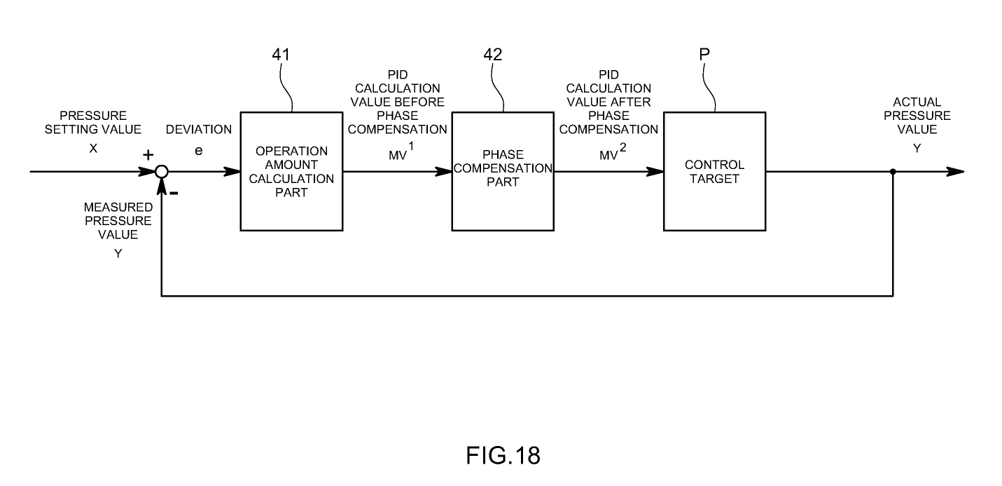

Specifically, the valve control mechanism 4 is configured to control the fluid control valve 2 such that a measured pressure value measured by the pressure sensor 3 becomes equal to a pressure setting value that is preliminarily set. The operation amount calculation part 41 in the valve control mechanism 4 is configured to perform a PID calculation on a deviation between the measured pressure value and the setting value to thereby calculate an operation amount for an opening level of the fluid control valve 2. Also, the phase compensation part 42 is configured to input as a feedback value to the fluid control valve 2 a value obtained by, with use of analog control, making phase compensation for the opening level operation amount calculated by the operation amount calculation part 41. Note that, in the fifth embodiment, calculation expressions and calculation circuit for control used in the valve control mechanism 4 are the same except that the control target is changed from the flow rate to the pressure and a corresponding block diagram is as illustrated in FIG. 18. Even in the case of configuring the fluid control device to be such a pressure control device, almost the same responsiveness as in the case where the control method of the whole of the valve control mechanism 4 is based on analog control can be achieved, and also by switching part of it from analog control to digital control, manufacturing costs can be reduced.

Other embodiments are described below.

In each of the above-described embodiments, as an example of fluid, a gas that is a compressible fluid is used as the control target; however, for example, incompressible liquid may be used as the control target.

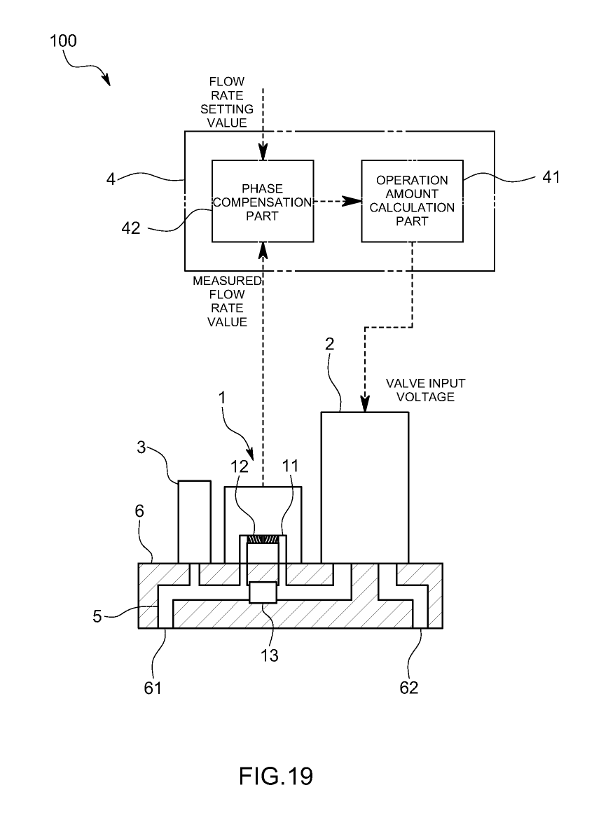

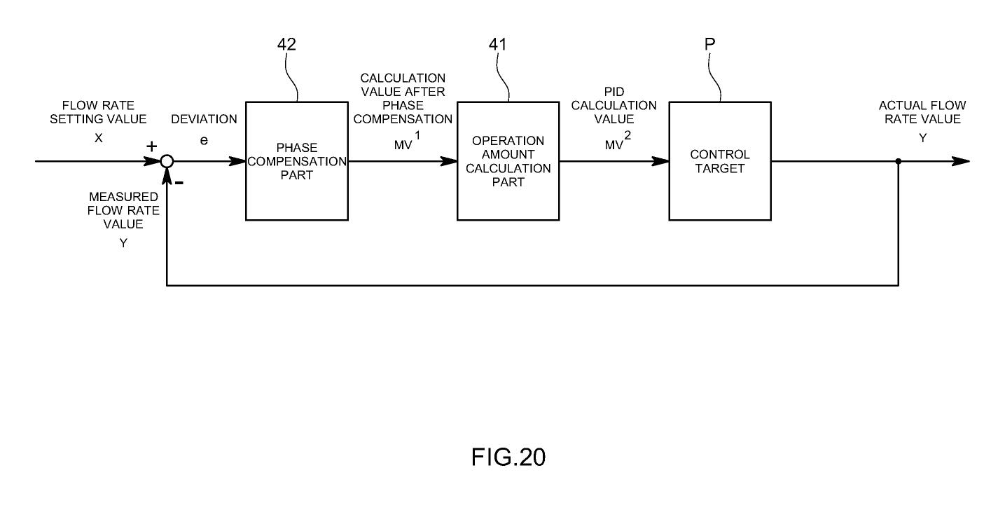

Also, the configuration of the valve control mechanism 4 described in each of the embodiments may be variously modified. For example, the operation amount calculation part 41 may calculate the operation amount by a method other than the PID calculation, such as PI calculation. Further, a method for the digital calculation in the operation amount calculation part 41 may be based on velocity type digital calculation or position type digital calculation. Still further, a control signal is processed in the order of the operation amount calculation part 41 and phase compensation part, but, as illustrated in FIGS. 19 and 20, may be processed in the reverse order. In addition, in the case of such a configuration, regarding the operation amount calculation part 41, it is only necessary to respectively replace e and MV¹ in Expressions 20 and 21 with MV¹ and MV². In short, it is only necessary to be an equivalent control block in a block diagram or the like, and, for example, the phase compensation part 42 may be configured to be an element that acts in the feedback loop. Also, an order in which the respective sensors and valve of the fluid control device 100 are arranged is not limited to any of those described in the above embodiments, but may be changed depending on the intended use such as control. In addition, an analog circuit constituting the phase compensation part 42 is not limited to the above-described analog circuit, but is only required to be an analog circuit equivalent to, for example, that which is expressed by Expression 22.

Also, an order in which the respective sensors and valve of the mass flow controller are arranged is not limited to any of those described in the above embodiments, but may be changed depending on the intended use, such as control. For example, in the first embodiment, from the upstream side, the flow rate sensor 1, the pressure sensor 3, and flow rate control valve 2 may be provided, in that order. In addition, on the basis of the measured pressure value outputted from the pressure sensor 3, the measured flow rate value, deviation, flow rate setting value may be corrected to further improve the responsiveness of the fluid control device. In particular, to describe the correction of the measured flow rate value outputted from the flow rate sensor 1, the flow rate calculation part may be configured to correct, on the basis of the pressure value indicated by the pressure sensor 3, a time variation of the pressure value, the flow rate setting value that has been set, and the like, the flow rate value calculated on the basis of the voltage values obtained from the respective coils 12, and then, output the resultant value to outside as the measured flow rate value.

In any of the above-described embodiments, the fluid control valve, fluid measurement part, and valve control mechanism are packaged into the one mass flow controller or pressure control device, but may not be packaged. For example, only the operation amount calculation part in the valve control mechanism may be configured to be a separate body with use of a general purpose computer such as a personal computer.

Beside, the embodiments may be combined or modified without departing from the scope of the present invention.

### REFERENCE CHARACTERS LIST

100: Fluid control device, Pressure control device

1, 3: Fluid measurement part, Pressure sensor

2: Fluid control valve

4: Valve controller

41: Operation amount calculation part

42: Phase compensation part

1. A fluid control device comprising:
a fluid control valve that is provided in a flow path through which fluid flows;
a fluid measurement part configured to measure a physical quantity related to the fluid; and
a valve controller configured to control, on a basis of a deviation between a physical quantity measured value that is measured in the fluid measurement part and a setting value that is preliminarily set, an opening level of the fluid control valve by digital control; wherein the valve controller comprises:
an operation amount calculation part configured to perform a predetermined calculation on an inputted value to output a value related to an operation amount for the opening level of the fluid control valve; and
a phase compensation part configured to output a value obtained by compensating an inputted value for a phase shift by velocity type digital calculation.

2. The fluid control device according to claim 1, wherein
the predetermined calculation used in the operation amount calculation part is a PID calculation.

3. The fluid control device according to claim 1, wherein
the predetermined calculation used in the operation amount calculation part is a velocity type digital calculation.

4. A pressure control device comprising:
a fluid control valve that is provided in a flow path through which fluid flows;
a pressure sensor configured to measure pressure of the fluid; and
a valve controller configured to control an opening level of the fluid control valve such that a measured pressure value measured in the pressure sensor becomes equal to a setting value that is preliminarily set; wherein the valve controller comprises:
an operation amount calculation part configured to perform a predetermined calculation on an inputted value to calculate a value related to an operation amount for the opening level of the fluid control valve; and
a phase compensation part configured to output a value obtained by compensating an inputted value for a phase shift by a digital calculation.

5. The pressure control device according to claim 4, wherein
the phase compensation part is configured to compensate for the phase shift by a velocity type digital calculation.

6. The pressure control device according to claim 4, wherein
the operation amount calculation part calculates the value related to the operation amount by a PID calculation.

7. The pressure control device according to claim 4, wherein
the operation amount calculation part calculates the value related to the operation amount by a velocity type digital calculation.

8. A fluid control device comprising:
a fluid measurement part that is provided in a flow path through which fluid flows, and measures a physical quantity related to the fluid;
a fluid control valve that is provided in the flow path; and
a valve control mechanism configured to control, on a basis of a deviation between a physical quantity measured value that is measured in the fluid measurement part and a setting value that is preliminarily set, an opening level of the fluid control valve;
wherein the valve control mechanism comprises:
an operation amount calculation part configured to perform a predetermined calculation on an inputted value to output a value related to an operation amount for the opening level of the fluid control valve; and
a phase compensation part that is an analog controller and configured to output an inputted value for a phase shift to provide an output.

9. The fluid control device according to claim 8, wherein
the operation amount calculation part calculates the value related to the operation amount by a PID calculation.

10. The fluid control device according to claim 8, wherein
the operation amount calculation part calculates the value related to the operation amount by a velocity type digital calculation.
